(19) United States
(12) Patent Application Publication
(10) Pub. No.: US 2009/0211843 A1
(43) Pub. Date: Aug. 27, 2009

(54) LADDER PAD ASSEMBLY AND SYSTEM

(76) Inventor: Stephen T. McClain, Austin, TX (US)

Correspondence Address: FISH & RICHARDSON P.C., P.O BOX 1022, Minneapolis, MN, 55440-1022, US

(21) Appl. No.: 12/390,218

(22) Filed: Feb. 20, 2009

Related U.S. Application Data
(60) Provisional application No. 61/030,465, filed on Feb. 21, 2008.

(51) Int. Cl. E06C 7/00

(52) U.S. Cl. 182/129

(57) ABSTRACT

Implementations of the present disclosure provide a ladder pad assembly for use with a ladder having at least one rail and at least one pair of rungs are provided. In some implementations, the ladder pad assembly includes a body having a volume of padding material provided therein, and a fastening arrangement that is attached to body. The body is configured to wrap around the rail to be at least partially disposed between rungs of the at least one pair of rungs, and the fastening arrangement is arranged to releasably secure the body to the rail.

### CROSS-REFERENCE TO RELATED APPLICATION

The present application claims the benefit of U.S. Prov. Pat. App. No. 61/030,465, Filed on Feb. 21, 2008, under 35 U.S.C. § 119(e). U.S. Prov. Pat. App. No. 61/030,465 is expressly incorporated herein by reference in its entirety for all purposes.

### FIELD

The present disclosure is generally directed toward pad assemblies, and more specifically to a ladder pad assembly and system.

### BACKGROUND

A ladder traditionally includes a pair of rails having a series of rungs extending therebetween. The rails are arranged to be generally parallel to one another, and the rungs connect the rails. The rungs typically serve as supports, or steps for an individual to ascend or descend the ladder. For example, the ladder can be arranged to lean against a vertical planar surface, such as a wall, for example, and an individual can climb, or ascend the ladder by sequentially stepping on the rungs.

Other ladders can be more complex and can include a plurality of rails on each side, as well as corresponding rungs. In the case of an extension ladder, for example, the side rails of each side can be provided in a nested configuration, and arranged to slide along each other to increase/decrease the length of the ladder. In the case of a step ladder, or foldable ladder, for example, the side rails of each side are arranged to pivot with respect to each other.

The ladder components including, but not limited to, the rails and rungs, must be sufficiently strong to support the weight of an individual, or in some cases, individuals, who may be ascending or standing on the ladder, as well as the weight of any other objects that the ladder may be supporting. Such other objects can include, but are not limited to, tools, paint cans, buckets, and the like. Consequently, the ladder components are manufactured from a material that is sufficiently strong to accommodate the loads that they may experience during use.

During transport, and/or use of the ladder, one or more components, the rails, for example, lean against or rest on a structure. As a result, the ladder components) can damage, mark, or scratch the surface of the structure.

### SUMMARY

In accordance with the present disclosure, implementations of a ladder pad assembly for use with a ladder having at least one rail and at least one pair of rungs are provided. In some implementations, the ladder pad assembly includes a body having a volume of padding material provided therein, and a fastening arrangement that is attached to body. The body is configured to wrap around the rail to be at least partially disposed between rungs of the at least one pair of rungs, and the fastening arrangement is arranged to releasably secure the body to the rail.

In some implementations, the body includes a cavity formed therein, which cavity retains the padding material.

In some implementations, the body and padding material are integrally formed from a common material.

In some implementations, the body includes a first section and a second section, the first section having a first elasticity and the second section having a second elasticity different than the first elasticity.

In some implementations, the ladder pad assembly further includes a securing mechanism that is attached to the body. In some implementations, the securing mechanism includes a ring. In other implementations, the securing mechanism includes a buckle component.

In some implementations, the fastening arrangement includes one or more of a hook and loop fastener, a snap fastener, a magnetic fastener, and a zipper fastener.

In other implementations, a ladder pad assembly for use with a ladder having at least one rail and at least one rung is provided, and includes a body having a pair of recesses and a volume of padding material provided therein, and a fastening arrangement that is attached to body. The body is configured to wrap around the rail to align recesses of the pair of recesses to define an opening, through which the at least one rung extends, and wherein the fastening arrangement is arranged to releasably secure the body to the rail.

In some implementations, each recess of the pair of recesses is sloped at an angle relative to a lateral axis of the body.

In some implementations, the body includes a first section and a second section, the first section having a first elasticity and the second section having a second elasticity different than the first elasticity.

In some implementations, the ladder pad assembly further includes a securing mechanism that is attached to the body, the securing mechanism comprising at least one of a ring, a buckle component, and a strap.

In some implementations, the fastening arrangement includes one or more of a hook and loop fastener, a snap fastener, a magnetic fastener, and a zipper fastener.

In some implementations, the fastening arrangement comprises a magnetic fastener comprising a magnet that is attached to a first extension of the body. In some implementations, the fastening arrangement further includes a ferromagnetic material that is attached to a second extension of the body, the first extension and the second extension lying adjacent to one another to secure the body to the rail.

In other implementations, a ladder padding and securing system is provided, and includes a strap, and a ladder pad assembly for use with a ladder having at least one rail and at least one rung. In such implementations, the ladder pad assembly includes a body having a volume of padding material provided therein, a securing arrangement that is attached to the body, and a fastening arrangement that is attached to body. The body is configured to wrap around the rail to be at least partially disposed between rungs of the at least one pair of rungs, and the fastening arrangement is arranged to releasably secure the body to the rail. The strap is selectively attachable to the securing arrangement to inhibit movement of the ladder pad assembly.

In some implementations, the body includes a pair of recesses that align to define an opening, through which the at least one rung extends. In such implementations, each recess of the pair of recesses can be sloped at an angle relative to a lateral axis of the body. In some implementations, each recess of the pair of recesses includes an acute corner, and a lateral axis of the body is tangent to each acute corner.

In some implementations, the body includes a first section and a second section, the first section having a first elasticity and the second section having a second elasticity different than the first elasticity.

The details of one or more implementations of the present disclosure are set forth in the accompanying drawings and the description below. Other features, objects, and advantages of the present disclosure will be apparent from the description and drawings, and from the claims.

### DESCRIPTION OF DRAWINGS

FIG. 1 is a plan view of an implementation of a ladder pad assembly in accordance with the present disclosure.

FIG. 2 is a partial perspective view of an exemplar ladder including the ladder pad assembly of FIG 1 affixed thereto.

FIG. 3 is a cross-sectional view along the line 3-3 of FIG 1.

FIG. 4 is a plan view of another implementation of a ladder pad assembly in accordance with the present disclosure.

FIG. 5 is a plan view of another implementation of a ladder pas assembly in accordance with the present disclosure.

FIG. 6 is a plan view of still another implementation of a ladder pad assembly in accordance with the present disclosure.

FIG. 7A is a cross-sectional view of a ladder pad assembly including an implementation of a fastening mechanism in accordance with the present disclosure.

FIG. 7B is a cross-sectional view of a ladder pad assembly including another implementation of a fastening mechanism in accordance with the present disclosure.

FIG. 7C is a cross-sectional view of a ladder pad assembly including another implementation of a fastening mechanism in accordance with the present disclosure.

FIG. 8 is a cross-sectional view of a ladder pad assembly including an implementation of a tie-down mechanism in accordance with the present disclosure.

FIG. 9 is a cross-sectional view of a ladder pad assembly including an implementation of a tie-down mechanism in accordance with the present disclosure.

Like reference symbols in the various drawings indicate like elements.

### DETAILED DESCRIPTION

A ladder typically includes a pair of spaced apart side rails, and a plurality of rungs that run between, and that connect the side rails. The rungs each provide a step, on which a person can step to ascend or descend the ladder. The rungs can also be used for other purposes including, but not limited to. a support, from which an object can hang, or on which an object can rest. Some ladders can include a plurality of side rails on each side, in the case of an extension ladder, the side rails of each side can be provided in a nested configuration, and arranged to slide relative to one another to increase/decrease the length of the ladder. In the case of a step ladder, or foldable ladder, for example, the side rails of each side are arranged to pivot with respect to each other.

The ladder components are typically made of a material having sufficient strength to support anticipated loads. Such loads can include, but are not limited to, a person, or persons, and objects, such as tools, paint cans, tool boxes, buckets, and the like. Exemplar materials can include, but are not limited to, steel, aluminum, metal alloys, plastic, plastic alloys, and nylon. Even in the case of nylon, plastics, and plastic alloys, the material typically includes a surface of sufficient hardness that it can damage, scratch, and/or otherwise mark a surface on which it rests.

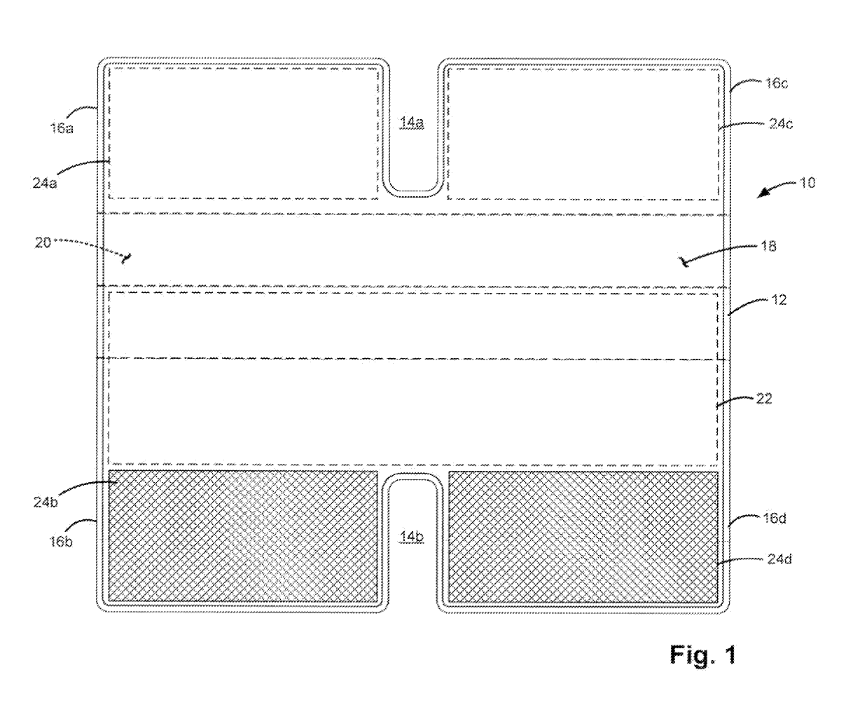

Referring now to FIG. 1, an exemplar ladder pad assembly 10 in accordance with the present disclosure is illustrated. The exemplar ladder pad assembly 10 of FIG. 1 includes an H-shaped body 12 having recesses 14a, 14b, and extensions 16a, 16b, 16c, 16d. Although, the exemplar ladder pad assembly 10 of FIG. 1 includes the H-shaped body 12, various shapes of the body 12 are contemplated in other implementations of the ladder pad assembly 10 of the present disclosure. The body 12 further includes a first side 18. and an opposing second side 20. A central portion of the body 12 defines a padded region 22, discussed in further detail below. The extensions 16a, 16b, 16c, 16d each define respective attachment regions 24a, 24b, 24c, 24d, in which attachment fixtures can be disposed.

In one implementation, a hook and loop type fastener arrangement can be used with the ladder pad assembly 10. Such an arrangement typically includes a first fastener strip that is releasably engageable with a second fastener strip. The first fastener strip can include a hook-type fastener strip, or a loop-type fastener strip. The second fastener strip includes the other of the hook-type fastener strip, and the loop-type fastener strip. For example, if the first fastener strip is provided as a hook-type fastener strip, then the second fastener strip is provided as a loop-type fastener strip, and vice-versa. In the case of a hook and loop type fastener arrangement, first fastener strips can be attached to the attachment regions 24a, 24c of respective extensions 16a, 16c on the second side 20 of the body 12, and second fastener strips can be attached to the attachment regions 24b, 24d of respective extensions 16b, 16d on the first side 18 of the body 12.

Although hook and loop type fastener arrangements are described above, it is contemplated that other fastener arrangements can be implemented, as discussed in further detail below. For example, snap, or button fasteners can be implemented, and/or zipper fasteners, as well as other fastener arrangements known in the art. It is also contemplated that a combination of fastener arrangements can by implemented.

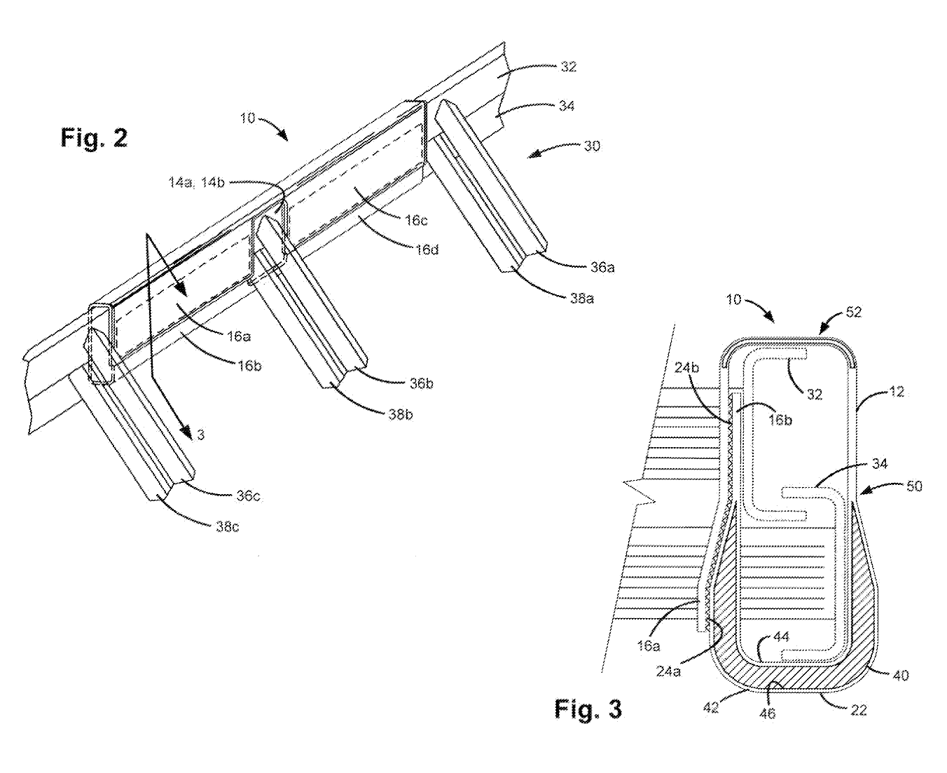

Referring now to FIGS. 2 and 3, a partial perspective view of an exemplar ladder 30 is illustrated. The exemplar ladder 30 is an extendable ladder that includes first and second rails. 32, 34, respectively, each of which includes corresponding rungs 36a, 36b, 36c, and 38a, 38b, 38c, respectively, extending therefrom. The first and second rails 32, 34 are partially nested within one another, and are arranged to be slidable relative to each other. The ladder pad assembly 10 is mounted to the ladder. More specifically, the ladder pad assembly 10 is wrapped around the rungs 32, 34, and the extensions 16a, 16c are connected to respective extensions 16b, 16d. The extensions 16a, 16b, 16c, 16d are located between neighboring rungs. More specifically, the coupled extensions 16a, 16b are located between the rungs 36b, 36c, 38b, 38c, and the coupled extensions 16c, 16d are located between the rungs 36a, 36b, 38a, 38b. The recesses 14a, 14b define an opening, through which the rungs 36b, 38b extend.

As discussed in detail above, the body 12 includes the padded region 22. The padded region 22 includes a volume of pad material 40. An exemplar pad material can include, but is not limited to, a foam pad material, such as a polyethylene foam, and/or a natural fiber pad material, such as cotton or wool. Other exemplar pad materials can include, but are not limited to, a visco-elastic foam material, such as a memory foam material. The pad materials identified above are exemplar pad materials, and it is contemplated that any pad material can be implemented. In general, the pad material 40 is preferably a resilient pad material that provides a cushioning function. The padded region 22, however, can also or alternatively include layers of material that provide the cushioning function.

With particular reference to FIG. 3, the padded region 22 is defined within the body 12. In one exemplar implementation, a single layer of material can be split to form a first layer 42 and a second layer 44, between which a cavity 46 is formed. The pad material 40 is secured within the cavity 46. In another exemplar implementation, the body 12 includes a first layer of material and a second layer of material. The first and second layers are connected together. For example, the first and second layers can be sewn, stitched, glued, and/or welded together. The cavity 46 is formed between the first and second layers in a region where the first and second layers are not connected.

The body 12 can be made from any of various materials known in the art. Exemplar materials include, but are not limited to, natural fiber fabric, synthetic fabric, stretch-fabric, nylon, neoprene, elastic material, and the like. It is also anticipated that the body 12 can include a combination of materials. In one exemplar implementation, as seen in FIG. 3, the body 12 can include a first section 50 of a first material, and a second section 52 of a second material. The second material can include an elastic material, for example, that enables the body to stretch around the rail 32. In this manner, the tightness, with which the ladder pad assembly 10 is secured to the rails 32, 34, can be adjusted.

It is also contemplated that the body 12, the padded region 22 and the volume of pad material 40 can be formed of a single, integral material. More specifically, the body 12 and pad material 40 can be formed from a continuous piece of common material to provide a monolithic pad assembly. In this manner, multiple, differing materials are not required, and the assembly of such multiple materials can be forgone.

The ladder pad assembly 10 of the present disclosure can be secured to one or more rails 32. 34 of the ladder 30 to protect the rail 32, 34, as well as protecting an object on which the ladder 30 may rest. For example, the ladder 30 may rest against a body panel of a vehicle, such as the roof of a vehicle, during transport. The ladder pad assembly 10, the padded region 22 in particular, can provide a cushion between the ladder 30 and the body panel to inhibit the ladder 30 from damaging, marking, or scratching the body panel. In another example, the ladder 30 may rest against a structure, such as a gutter, siding, or an awning of a house, during use of the ladder 30. The ladder pad assembly 10, the padded region 22 in particular, can provide a cushion between the ladder 30 and the structure to inhibit the ladder from damaging, marking, or scratching the structure. Furthermore, in the case of an extension ladder, and/or a foldable ladder, the ladder pad assembly 10 can inhibit relative movement of the ladder components, the rails in particular.

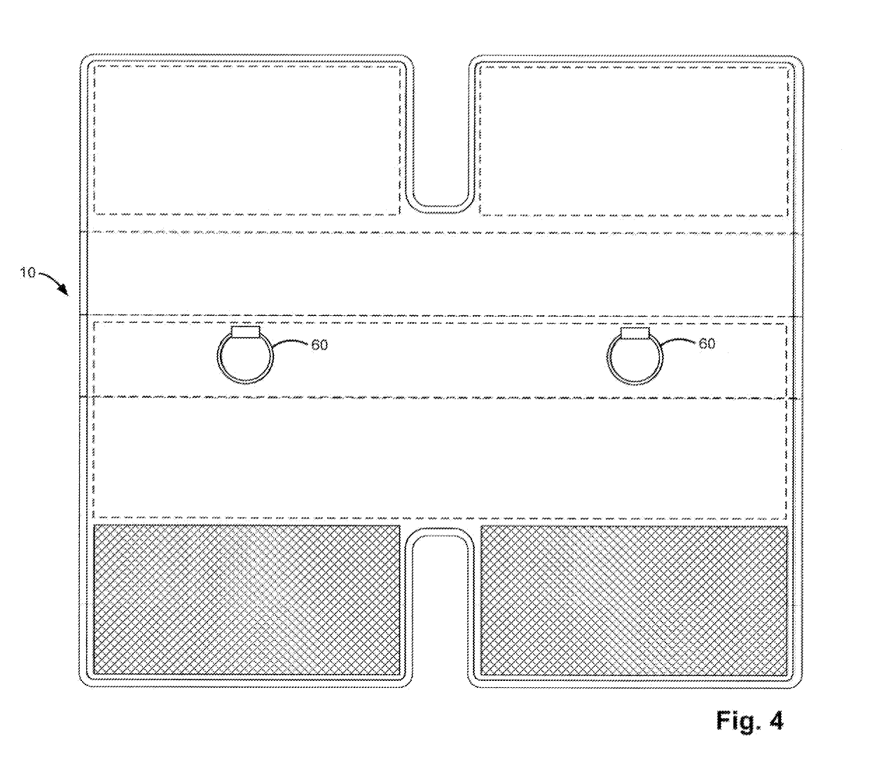

Referring now to FIG. 4, the ladder pad assembly 10 can include additional features. In the exemplar implementation of FIG. 4, the ladder pad assembly 10 includes one or more rings 60 secured to the body 12. Although the rings 60 are illustrated as round rings, it is anticipated that the rings 60 can include any shape including, but not limited to, square, rectangular, and/or triangular. Furthermore, although the rings 60 are attached to the body 12 in the padded region 22, it is contemplated that the rings 60 can be attached to the body 12 in any location. The rings 60 can be made from any of a number of materials including, but not limited to, metal, plastic, and nylon. In one example, the rings 60 provide a structure for securing the ladder during transport. For example, if the ladder is transported on a vehicle, securing straps can be threaded through the rings to secure the ladder to the vehicle, thereby inhibiting movement of the ladder during transport. In another example, the rings 60 provide a structure for attaching objects to the ladder. For example, a bucket, or tool belt and be hung from the rings. In this manner, a person that is using the ladder can have tools, paint, and the like readily available.

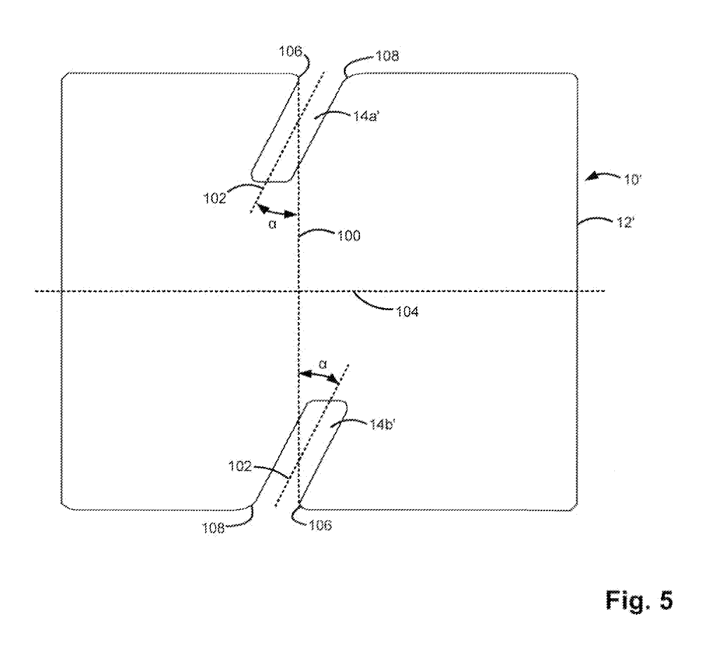

Referring now to FIG 5, another implementation of a ladder pad assembly 10′ in accordance with the present disclosure is illustrated. The exemplar ladder pad assembly 10′ of FIG. 5 is similarly constructed to ladder pad assembly 10 of FIG. 1. Ladder pad assembly 10′, however, includes a body 12′ having sloped or slanted recesses 14a′, 14b′. More specifically, each of the recesses 14a′, 14b′ is slanted at an angle a defined between a lateral axis 100 of the body 12′, and respective recess axes 102. The longitudinal axis 104 of the body 12′ lies perpendicular to the lateral axis 100. The recesses 14a′, 14b′ include respective acute corners 106 and respective obtuse corners 108. The respective acute corners 106 are arranged such that they are aligned along the lateral axis 100. For example, the lateral axis 100 lies tangent to each of the acute angles 106.

When ladder pad assembly 10′ is assembled onto a ladder, the recesses 14a′, 14b′ define an opening, through which the rungs can extend. With some ladders, the rungs can include a sloped or slanted configuration. Accordingly, the recesses 14a′, 14b′ combine to define a correspondingly sloped or slanted opening to accommodate the rungs. More specifically, as the ladder pad assembly 10′ is caused to wrap around a rail, the recesses 14a′, 14b′ align to define a single sloped opening, through which the rungs extend.

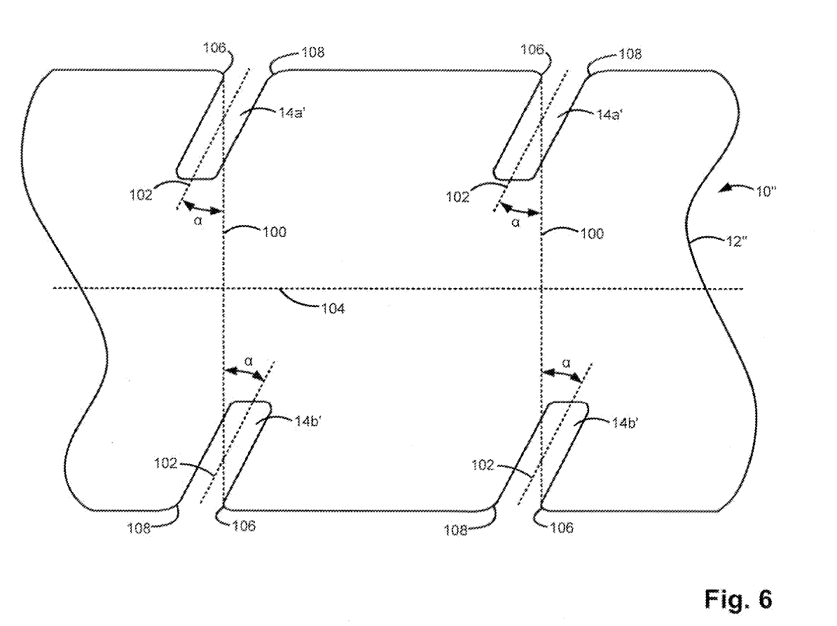

Referring now to FIG. 6. another implementation of a ladder pad assembly 10″ in accordance with the present disclosure is illustrated. The exemplar ladder pad assembly 10″ of FIG. 6 is similarly constructed to ladder pad assembly 10′ of FIG. 5. Ladder pad assembly 10″, however, includes a body 12″ having a first and a second set of sloped or slanted recesses 14a′, 14b′. More specifically, each of the recesses 14a′, 14b′ is slanted at an angle a defined between respective lateral axes 100 of the body 12″, and respective recess axes 102. The longitudinal axis 104 of the body 12′ lies perpendicular to the lateral axes 100. Again, the recesses 14a′, 14b′ include respective acute corners 106 and respective obtuse comers 108. The respective acute comers 106 are arranged such that they are aligned along the lateral axis 100. For example, the lateral axes 100 lies tangent to each of the respective acute angles 106.

When ladder pad assembly 10″ is assembled onto a ladder, the first and second sets of recesses 14a′, 14b′ define respective first and second openings, through which the respective rungs can extend. With some ladders, the rungs can include a sloped or slanted configuration. Accordingly, the first and second sets of recesses 14a′, 14b′ combine to define a correspondingly sloped or slanted openings to accommodate the rungs. More specifically, as the ladder pad assembly 10′ is caused to wrap around a rail, the first and second sets of recesses 14a′, 14b′ align to define respective sloped openings, through which the respective rungs extend.

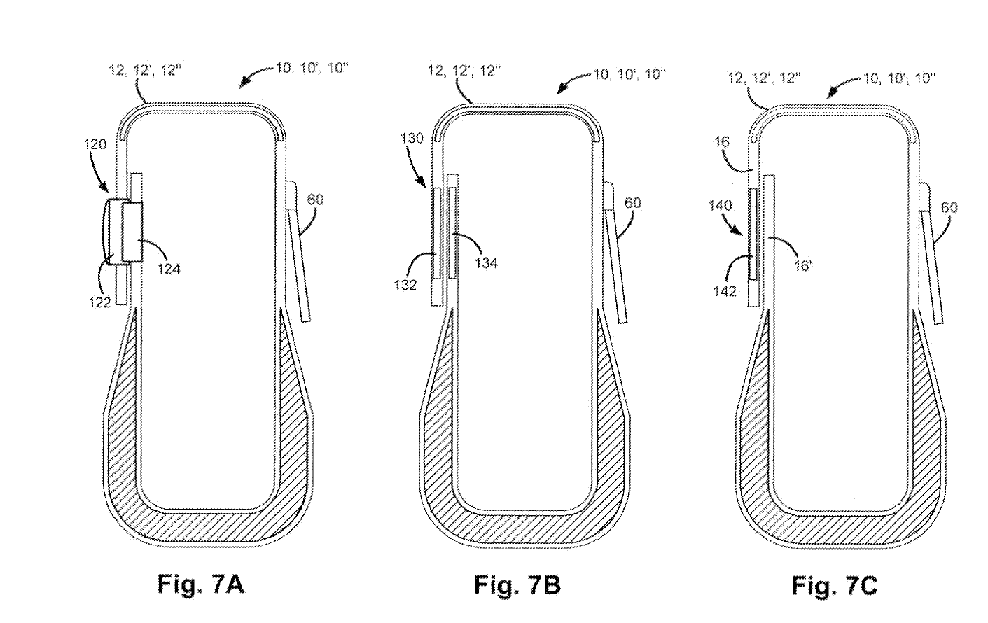

Referring now to FIGS. 7A-7C, other exemplar fastening mechanisms will be described in detail. Although each of FIGS. 7A-7C is illustrated as including the rings 60, it is contemplated that implementations can also be provided without the rings 60 and/or with other securing mechanisms. With particular reference to FIG. 7A, an exemplar fastening mechanism includes a snap fastener 120 (e.g., a post-style snap and/or a prong-style snap). The snap fastener 120 includes a closure unit 122 and an attaching unit 124. The closure unit 122 and the attaching unit 124 include a press lit that enables the units 122, 124 to be snapped together or engaged through application of sufficient pressing force. In this manner, the ladder pad assembly 10, 10′, 10″ can be secured to the rail. By applying a sufficient pulling force, the units 122, 124 can be disengaged.

With particular reference to FIG 7B, another exemplar fastening mechanism includes a two-part magnetic fastener 130 that includes a first part 132 and a second part 134. The first part 132 can include one of a magnet or a ferromagnetic strip, while the second part 134 can include the other of a magnet or a ferromagnetic material. More specifically, in the case where the first part 132 includes a magnet, the second part 134 includes a ferromagnetic material. In the case where the first part 132 includes a ferromagnetic material, the second part 134 includes a magnet. Each of the first and second parts can be integrated within the body of the ladder pad assembly 10, 10′, 10″, can be mounted on an external surface of the body, and/or can be partially integrated within the body to be exposed on the external surface. As the ladder pad assembly 10, 10′, 10″ is assembled about a rail of a ladder, the first and second parts 132, 134 can be aligned adjacent to one another, and the magnetic attraction therebetween secured the first and second parts 132, 134 to one another. In this manner, the ladder pad assembly 10, 10′, 10″ can be secured to the rail.

With particular reference to FIG. 7C, another exemplar fastening mechanism includes a one-part magnetic fastener 140. The fastening mechanism includes a magnet 142 provided in an outside attachment region 24. The magnet 142 can be integrated within the body of the ladder pad assembly 10, 10′, 10″, can be mounted on an external surface of the body, or can be partially integrated within the body to be exposed on the external surface. As the ladder pad assembly 10, 10′, 10″ is assembled about a rail of a ladder, the outside attachment region lies adjacent to an inside attachment region 24′. The magnetic attraction between the magnet 142 and the underlying rail sandwiches the inside attachment region 24′ between the outside attachment region 24 and the rail, securing the ladder pad assembly 10, 10′, 10″ to the rail. This particular implementation is preferably employed with rails made from a ferromagnetic material.

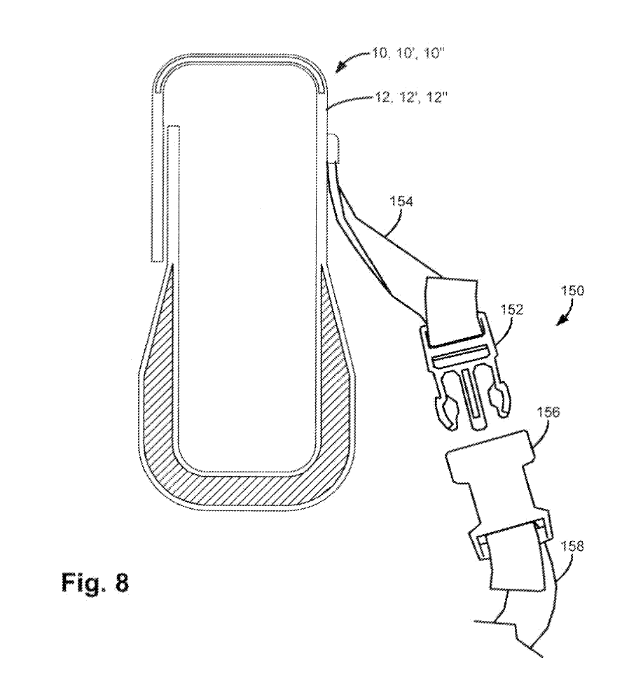

Referring now to FIG 8, an implementation of a tie-down mechanismv 150 in accordance with the present disclosure will be described. The tie-down mechanism 150 includes a buckle component 152 that is secured to the body of the ladder pad assembly 10, 10′, 10″. Although the buckle component 152 is illustrated as a male buckle component of an exemplar buckle type, the buckle component 152 can include an alternative type, and/or a female buckle component. In the implementation of FIG. 8, the buckle component 152 is adjustably secured to the body via a strap 154. In this manner, the distance of the buckle component 152 from the body can be adjusted. In other implementations, the buckle component 152 can be non-adjustably secured to the body.

The buckle component 152 of the implementation of FIG. 8 can be selectively coupled to a mating buckle component 156 of a separate tie-down strap 158. Although the mating buckle component 156 is illustrated as a female buckle component of an exemplar buckle type, the buckle component 156 can include an alternative type, and/or a male buckle component. For example, the mating buckle component 156 is a female buckle component in the case where the buckle component 152 is a male buckle component, and vice-versa. The mating buckle component 156 can be adjustably or non-adjustably secured to the tie-down strap 158.

The buckle component 152 and mating buckle component 156 can be selectively coupled to provide a mechanism for securing the ladder during transport, or use. For example, if the ladder is transported on a vehicle, the tie-down strap 158 can be secured to the ladder pad assembly 10, 10′, 10″ and can be secured to a vehicle to secure the ladder to the vehicle. In this manner, movement of the ladder can be inhibited during transport. In another example, the buckle components 152, 156 can provide a mechanism for attaching objects to the ladder. For example, a bucket, or tool belt and be secured to the strap 158, which can be secured to the ladder pad assembly 10, 10′, 10″ via the strap 154 and the buckle components 152, 156. In this manner, a person that is using the ladder can have tools, paint, and the like readily available. In still another example, the buckle components 152, 156 and straps 154, 158 can be employed to secure the ladder during use. For example, the strap 158 can be secured to an immovable object, and the ladder pad assembly 10, 10′, 10″ can be secured to the immovable object through the strap 154, the buckle components 152, 156 and the strap 158. In this manner, movement of the ladder during use can be inhibited to prevent the ladder from slipping, or falling away from the structure.

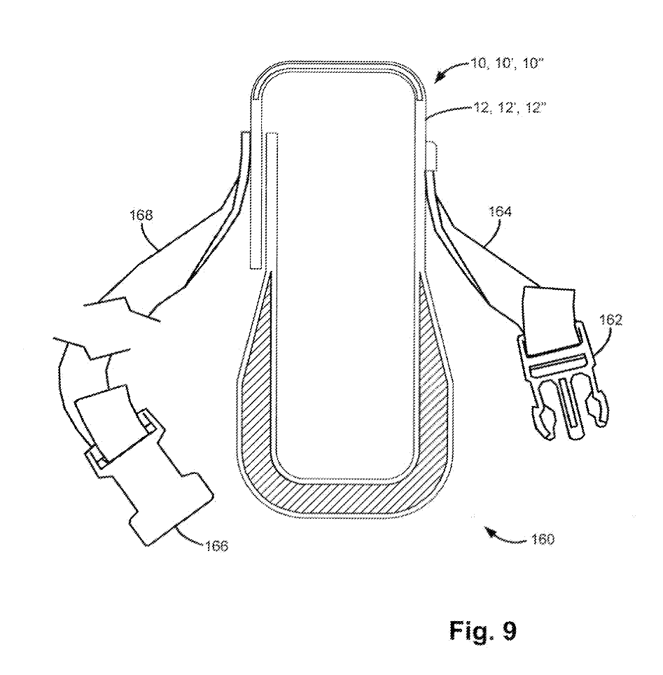

Referring now to FIG 9, another implementation of a tie-down mechanism 160 in accordance with the present disclosure will be described. The tie-down mechanism 160 includes first and second mating buckle components 162, 166 that are secured to the body of the ladder pad assembly 10, 10′, 10″. The first buckle component 162 is illustrated as a male buckle component of an exemplar buckle type. However, the buckle component 162 can include an alternative type, and/or a female buckle component. The second buckle component 166 is illustrated as a female buckle component of an exemplar buckle type. However, the second buckle component 166 can include an alternative type, and/or a male buckle component. For example, if the first buckle component 162 is provided as a male buckle component, the second buckle component 166 is provided as a female buckle component, and vice-versa.

Each of the first and second buckle components 162. 166 can be adjustably or non-adjustably secured to respective tie-down straps 164, 168. The first and second buckle components 162, 166 and the tie-down straps 164, 168 can be employed to secure the ladder to a structure, such as a vehicle. For example, the first and second buckle components 162, 166 can be selectively coupled to secure the ladder to a structure. More specifically, the first and second buckle components 162, 166 and tic-down straps 164, 168 can be employed to secure the ladder to an immovable structure during use. In this manner, movement of the ladder can be inhibited to prevent the ladder from slipping, or falling away from the structure.

A number of implementations of the ladder pad assembly have been described. Nevertheless, it will be understood that various modifications may be made without departing from the spirit and scope of the present disclosure. Accordingly, other implementations are within the scope of the following claims.

What is claimed is:

1. A ladder pad assembly for use with a ladder having at least one rail and at least one pair of rungs, comprising:
a body having a volume of padding material provided therein; and
a fastening arrangement that is attached to body;
wherein the body is configured to wrap around the rail to be at least partially disposed between rungs of the at least one pair of rungs, and the fastening arrangement is arranged to releasably secure the body to the rail.

2. The ladder pad assembly of claim 1, wherein the body includes a cavity formed therein, which cavity retains the padding material.

3. The ladder pad assembly of claim 1, wherein the body and padding material are integrally formed from a common material.

4. The ladder pad assembly of claim 1, wherein the body includes a first section and a second section, the first section having a first elasticity and the second section having a second elasticity different than the first elasticity.

5. The ladder pad assembly of claim 1, further comprising a securing mechanism that is attached to the body.

6. The ladder pad assembly of claim 5, wherein the securing mechanism includes a ring.

7. The ladder pad assembly of claim 5, wherein the securing mechanism includes a buckle component.

8. The ladder pad assembly of claim 1, wherein the fastening arrangement includes one or more of a hook and loop fastener, a snap fastener, a magnetic fastener, and a zipper fastener.

9. A ladder pad assembly for use with a ladder having at least one rail and at least one rung, comprising:
a body having a pair of recesses and a volume of padding material provided therein; and
a fastening arrangement that is attached to body;
wherein the body is configured to wrap around the rail to align recesses of the pair of recesses to define an opening, through which the at least one rung extends, and wherein the fastening arrangement is arranged to releasably secure the body to the rail.

10. The ladder pad assembly of claim 9, wherein each recess of the pair of recesses is sloped at an angle relative to a lateral axis of the body.

11. The ladder pad assembly of claim 9, wherein the body includes a first section and a second section, the first section having a first elasticity and the second section having a second elasticity different than the first elasticity.

12. The ladder pad assembly of claim 9, further comprising a securing mechanism that is attached to the body, the securing mechanism comprising at least one of a ring, a buckle component, and a strap.

13. The ladder pad assembly of claim 9, wherein the fastening arrangement includes one or more of a hook and loop fastener, a snap fastener, a magnetic fastener, and a zipper fastener.

14. The ladder pad assembly of claim 9, wherein the fastening arrangement comprises a magnetic fastener comprising a magnet that is attached to a first extension of the body.

15. The ladder pad assembly of claim 14, wherein the fastening arrangement further comprises a ferromagnetic material that is attached to a second extension of the body, the first extension and the second extension lying adjacent to one another to secure the body to the rail.

16. A ladder padding and securing system, comprising:
a strap;
a ladder pad assembly for use with a ladder having at least one rail and at least one rung, the ladder pad assembly comprising:
a body having a volume of padding material provided therein;
a securing arrangement that is attached to the body; and
a fastening arrangement that is attached to body, wherein the body is configured to wrap around the rail to be at least partially disposed between rungs of the at least one pair of rungs, and the fastening arrangement is arranged to releasably secure the body to the rail;
wherein the strap is selectively attachable to the securing arrangement to inhibit movement of the ladder pad assembly.

17. The ladder padding and securing system of claim 16, wherein the body comprises a pair of recesses that align to define an opening, through which the at least one rung extends.

18. The ladder padding and securing system of claim 17, wherein each recess of the pair of recesses is sloped at an angle relative to a lateral axis of the body.

19. The ladder padding and securing system of claim 17, wherein each recess of the pair of recesses includes an acute corner, and wherein a lateral axis of the body is tangent to each acute corner.

20. The ladder padding and securing system of claim 16, wherein the body includes a first section and a second section, the first section having a first elasticity and the second section having a second elasticity different than the first elasticity.
